(19) United States
(12) Patent Application Publication
(10) Pub. No.: US 2010/0230933 A1
(43) Pub. Date: Sep. 16, 2010

(54) Stroller Adapter for an Infant Car Seat

(75) Inventors: Roy Lucas Dean, Pottstown, PA (US); Thomas Perrin, Alpharetta, GA (US); Marc Andrew Paradiso, Mableton, GA (US); Brady Matthew Schroeder, Milton, GA (US)

Correspondence Address: Lempia Braidwood Graco, One North LaSalle Street Suite 3150, Chicago, IL, 60602, US

(73) Assignee: Graco Children's Products Inc., Atlanta, GA (US)

(21) Appl. No.: 12/725,264

(22) Filed: Mar. 16, 2010

Related U.S. Application Data
(60) Provisional application No. 61/160,626, filed on Mar. 16, 2009.

(51) Int. Cl. B62B 9/10

(52) U.S. Cl. 280/647

(57) ABSTRACT

A juvenile product includes a frame, a hub assembly mounted on the frame and including first and second hubs, and first and second seat supports coupled to the first and second hubs, respectively, for pivotal movement between an in-use orientation and a folded orientation. The first hub includes a cam to release the first and second seat supports for the pivotable movement toward the folded orientation in response to rotation of the first seat support.

### CROSS-REFERENCE TO RELATED APPLICATION

This application claims the benefit of U.S. provisional application entitled “Stroller Adapter for an Infant Car Seat,” filed Mar. 16, 2009, and assigned Ser. No. 61/160,626, the entire disclosure of which is hereby expressly incorporated by reference.

### BACKGROUND OF THE DISCLOSURE

1. Field of the Disclosure

The present disclosure is generally directed to strollers, and more particularly to strollers having an adapter for an infant car seat.

2. Description of Related Art

Some strollers can be re-configured to accommodate an infant car seat carrier. A typical approach involves an adapter coupled to a seat frame of the stroller to present mounting points for securing the infant car seat carrier to the seat frame.

Unfortunately, infant car seat adapters have complicated the folding of strollers for storage and stowage. Adapters are usually non-folding, thereby forcing the caregiver to remove the adapter before folding the stroller frame. Once removed, the adapter can easily be misplaced, lost, or damaged. If left on, the adapter often impedes the folding sequence for the stroller frame to an undesirable extent. The result can be a folded orientation that is significantly less compact, or a stroller incapable of reaching the folded orientation.

Existing infant car seat adapters have also been undesirably complex, both in appearance and function. The appearance of a typical adapter has been found by caregivers to be intimidating, which can lead to non-use or improper installation. The complexity can also lead to an inability to decouple the adapter from the stroller, which, in turn, can lead to an inability to fold the stroller for stowage in a vehicle or other storage. The complex appearance of the adapter may also lead to problems, when, for instance, the caregiver remains unsure as to whether the infant car seat is securely and correctly mounted. That is, the complexity of the adapter leaves the caregiver uncomfortably uncertain even when the infant car seat is safely secured to the stroller.

### SUMMARY OF THE DISCLOSURE

In accordance with one aspect of the disclosure, a juvenile product includes a frame, a hub assembly mounted on the frame and including first and second hubs, and first and second seat supports coupled to the first and second hubs, respectively, for pivotal movement between an in-use orientation and a folded orientation. The first hub includes a cam to release the first and second seat supports for the pivotable movement toward the folded orientation in response to rotation of the first seat support.

In some cases, the cam includes a cam slot. The hub assembly may then include a pin that travels in the cam slot and couples the first and second hubs. The pin may include a flange, and the second hub may then include a groove in which the flange is captured to hold the first and second hubs axially together.

Alternatively or additionally, the hub assembly includes a third hub and a pin that engages the cam and includes first and second flanges that engage the second and third hubs, respectively.

The hub assembly may include a pin controlled by the cam and a slot follower engaged by the pin. The slot follower may include an arc-shaped track in which the pin travels to allow the first and second seat supports to reach the folded orientation.

In accordance with another aspect of the disclosure, a juvenile product includes a frame, an infant car seat adapter mounted on the frame and including a pair of hub assemblies, and a shroud that enwraps the infant car seat adapter to cover the hub assemblies. Each hub assembly includes a passive fold lock such that the infant car seat adapter can be moved between an in-use orientation and a folded orientation while the hub assemblies remain covered by the shroud.

In some cases, each hub assembly is mounted on the frame and includes first and second hubs. The infant car seat adapter may include first and second seat supports coupled to the first and second hubs, respectively, for pivotal movement between the in-use and folded orientations. The first hub may include a cam to release the first and second seat supports for the pivotable movement toward the folded orientation in response to rotation of the first seat support.

The passive fold lock may include a cam slot. Each hub assembly may include a pin that travels in the cam slot.

### BRIEF DESCRIPTION OF THE DRAWINGS

Objects, features, and advantages of the present invention will become apparent upon reading the following description in conjunction with the drawing figures, in which like reference numerals identify like elements in the figures.

FIG. 1 is a perspective view of a stroller constructed in accordance with several aspects of the disclosure.

FIG. 2 is a partial, perspective view of the stroller of FIG. 1 to depict an exemplary infant car seat adapter configured in accordance with one embodiment.

FIG. 3 is an exploded, perspective view of the stroller of FIG. 1 with an infant car seat removed to depict the mounting of the infant car seat adapter in greater detail.

FIG. 4 is a front, perspective view of the infant car seat adapter shown in FIGS. 2 and 3 to depict an exemplary pair of hub assemblies thereof in greater detail.

FIG. 5 is an exploded, perspective view of the infant car seat adapter shown in FIGS. 2 and 3.

FIG. 6 is an exploded, perspective view of one of the hub assemblies shown in FIG. 4 to depict an exemplary cam-based folding mechanism thereof.

FIG. 7 is a partial, front, perspective view of the hub assembly of FIG. 6 with the exemplary cam-based, passive folding mechanism disposed in a locked state for an in-use orientation of the car seat adapter.

FIG. 8 is a side, perspective view of the hub assembly of FIG. 6 with the exemplary cam-based, passive folding mechanism disposed in the locked state for the in-use orientation of the car seat adapter.

FIG. 9 is a side, perspective view of the hub assembly of FIG. 6 with the exemplary cam-based, passive folding mechanism disposed in a released state during a transition between the in-use orientation and a folded orientation of the car seat adapter.

FIG. 10 is a side, perspective view of the hub assembly of FIG. 6 with the exemplary cam-based, passive folding mechanism in a folded state for the folded orientation of the car seat adapter.

FIGS. 11 and 12 are exploded, perspective views of a hub assembly constructed in accordance with another embodiment and having an alternative cam-based, passive folding mechanism.

FIG. 13 is a partial, perspective view of the hub assembly of FIGS. 11 and 12 with the alternative folding mechanism disposed in a locked state for the in-use orientation of the car seat adapter.

FIG. 14 is a side, perspective view of the hub assembly of FIGS. 11 and 12 with the alternative folding mechanism disposed in a released state during a transition between the in-use orientation and a folded orientation of the car seat adapter.

FIG. 15 is a side, perspective view of the hub assembly of FIGS. 11 and 12 with the alternative folding mechanism disposed in a folded state for the folded orientation of the car seat adapter.

FIGS. 16A and 16B are front and rear perspective views of another alternative hub assembly having a cam-based, passive folding mechanism constructed in accordance with the disclosure.

### DETAILED DESCRIPTION OF THE DISCLOSURE

The disclosure is generally directed to strollers having an infant car seat adapter of reduced complexity in installation, operation, and reconfiguration. As a result, the disclosed adapters avoid the problems identified above, including, for instance, the inability to fold the stroller with the adapter secured thereto. For this reason, the disclosed adapters provide the same or greater functionality as past adapters despite having a lower number of parts. For example, the disclosed adapters are capable of reaching a folded or compact orientation without requiring an active release and despite the absence of complex arrangements of numerous parts. The advantages of reducing the number of components in the adapter include lower material and assembly costs.

In some cases, the disclosed adapters include a passive folding mechanism to lock or otherwise dispose the adapter in an in-use position or orientation and a folded position or orientation. In this way, the adapter need not rely on a user-activated fold release mechanism that may be undesirably complex. In these and other cases, the adapter may also include a passive, spring-loaded attachment mechanism to secure the adapter to the stroller or seat frame. In these and other ways, the disclosed adapters differ from past stroller adapters that were complex, non-folding assemblies, while maintaining or exceeding the functionality of those often expensive assemblies.

The disclosed adapters are generally configured for movement to a compact folded orientation so that the adapter can remain mounted on or secured to the stroller when the stroller is folded. Moreover, the compact fold orientation does not add significantly to the folded package size. Despite these fold-related advantages, the exemplary attachment mechanism described herein makes detachment or disengagement of the adapter very straightforward for the caregiver. In this way, the caregiver is provided with two straightforward options when the infant car seat, or the stroller, is not in use, namely removal or reconfiguration to the folded orientation.

In accordance with one aspect of the disclosure, the disclosed adapters are configured such that insertion of the infant car seat locks the folding mechanism in the in-use orientation. As shown in the examples described and shown herein, there is no user-actuated fold release. Instead, if the disclosed adapter is not being used (e.g., by not having an infant car seat installed), then the adapter is not locked or otherwise prevented from reconfiguration into, for instance, the folded orientation. Conversely, upon insertion of the car seat into (or onto) the adapter, the fold mechanism is now locked or securely disposed in the in-use position. Moreover, even if the car seat is inserted or mounted incorrectly, the presence of the car seat itself can prevent the fold operation from being implemented. As a result, the disclosed adapters establish a stable and secure in-use arrangement despite (i) the lack of an active release, and (ii) the possibility of reconfiguration to a folded orientation.

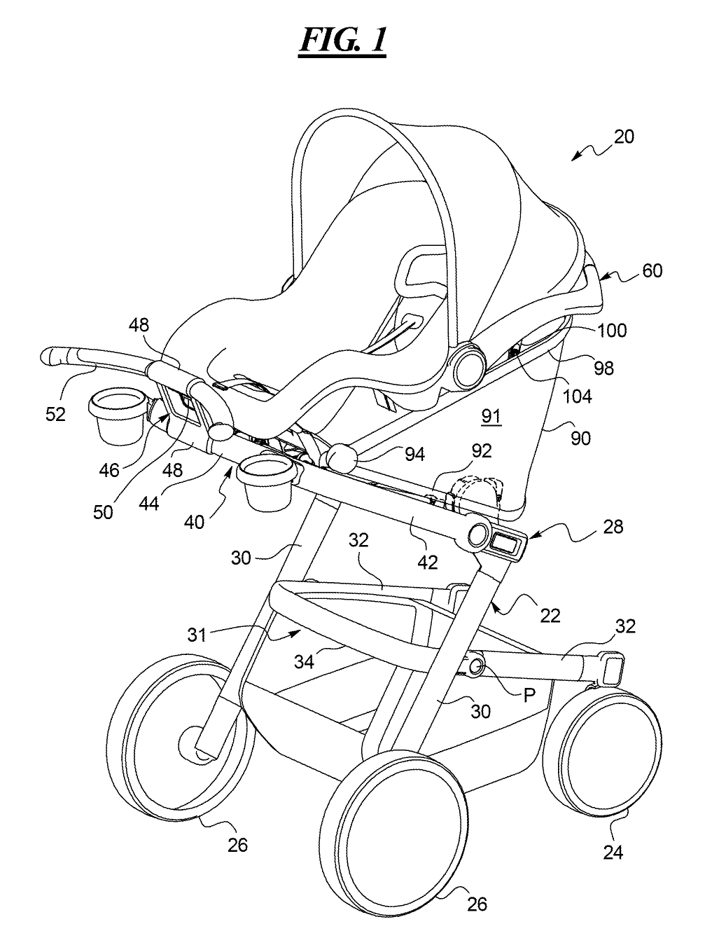

Turning now to the drawing figures, FIG. 1 depicts a stroller assembly 20 constructed in accordance with several aspects of the disclosure. The disclosed stroller assembly 20 utilizes but one of many alternate stroller frame configurations and constructions that may benefit from the teachings of the disclosure. In the disclosed example, the stroller assembly 20 has a frame assembly 22 supported by a pair of front wheels 24 and a pair of rear wheels 26 as is generally known in the art. In this example, the frame assembly 22 has a pair of opposed sides, each with a pivotable fold joint 28 connecting components of the frame assembly. Each frame side in this example has a rear leg 30 extending down from the corresponding fold joint 28 on the respective side. A lower end of each rear leg 30 is coupled to one of the rear wheels 26 in a conventional manner. In this example, a U-shaped front leg tube assembly 31 has a pair of front legs 32. Each front leg 32 extends forward and terminates at a lower end attached to one of the front wheels 24 in a conventional manner. The U-shaped front leg tube assembly 31 also includes a cross bar 34 interconnecting the opposite upper ends of the two front legs 32.

The leg tube assembly 31 is pivotally coupled to the frame assembly 22 with one front leg 32 pivotally connected at a pivot P to a respective one of the rear legs 30 so as to permit folding of the frame assembly 22 as is also known in the art.

In the disclosed example, the stroller assembly 20 also includes a handle assembly 40, which in this example is pivotally coupled to the upper ends of the rear legs 30 at the respective fold joints 28. The handle assembly 40 in the disclosed example generally includes a pair of laterally spaced apart push bars 42 extending upward and rearward from the respective fold joints 28. The handle assembly 40 is formed having a continuous U-shaped tube structure that includes the two push bars 42, and a curved connecting section 44, which extends between the upper ends of the push bars 42. In the disclosed example, a stanchion assembly 46 extends upward and rearward from the connecting section 44 of the handle assembly 40. In the disclosed example the stanchion assembly 46 has a pair of connectors 48, which are laterally spaced apart from one another and project way from the connecting section 44. A latch actuator 50 is positioned between the connectors 48. A curved handle bar 52 or handle is coupled to the distal ends of the connectors 48 coincident with the actuator 50. The handle bar 52 is generally C-shaped generally to support closer contact between child and caregiver during stroller usage.

In general, the actuator 50 can be pulled by a user inward toward the handle bar or handle 52. This movement of the actuator 50 will in turn release latches at the respective fold joints 28 as is known in the art. In one example, cables (not shown) can extend internally through the tubes of the connectors 48, the connecting section 44, and the push bars 42 in order to interconnect the actuator 50 with the latches 54 at each fold joint 28. Though not shown herein, when the actuator 50 is actuated and the fold joint latches 54 are released, the handle assembly 40 can be pivoted downward toward the rear legs 30. The front legs 32 will pivot about the pivot points P relative to the rear legs 30 as the rear legs drop downward. Thus, the frame assembly 22 can be folded to a folded configuration as is known in the art.

The frame assembly 22 is generally provided with multiple mounting elements for interconnecting an infant carrier 60 to the frame assembly 22. The mounting elements of the frame assembly 22 are generally passive, while one or more connecting elements on the infant carrier 60 may involve manual actuation to secure and/or release the infant carrier 60 from the mounting elements. Other mounting elements may typically involve only passive engagement with a cooperating structure on the carrier 60.

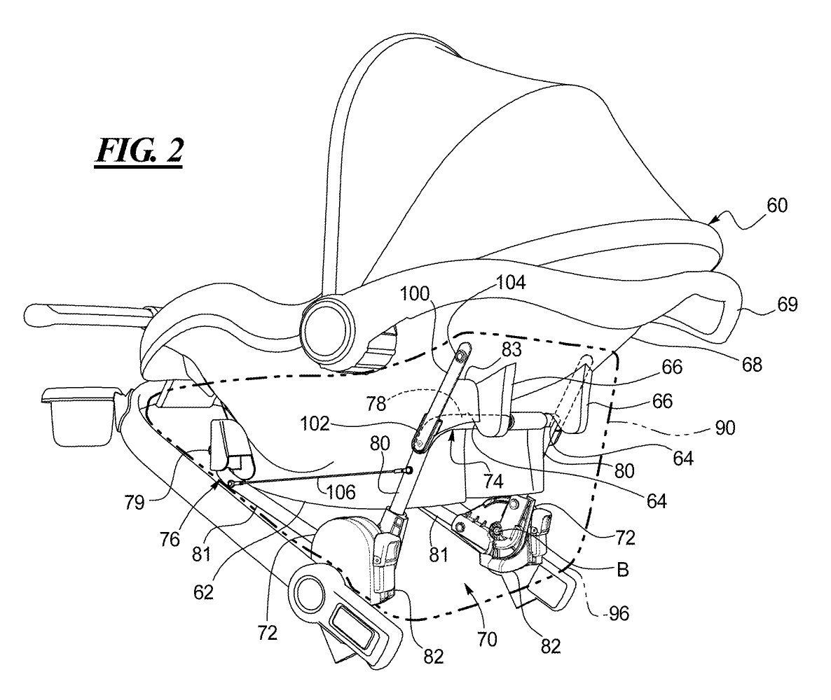

As shown in FIG. 2, the infant carrier 60 in this example has a bottom 62 with one or more upward formed recesses 64 in one or more downwardly projecting hooks 66 on the bottom. A release handle or actuator (not shown) is typically provided on or along a seat shell 68 that extends upward from the bottom 62 or a carrier handle 69 pivotably coupled to the seat shell 68. The release handle or actuator may be configured to move one or more latches or other hooks (not shown) of the carrier 60 from a secured position to a release position. In this example, these active connecting elements of the carrier 60 may be located at a foot or forward end of the carrier 60, while passive connecting elements (e.g., the hooks 66 and the recesses 64) are disposed at or near the head or rear end of the carrier 60. Notwithstanding the foregoing, the carrier 60 may alternatively or additionally include passive mounting points and structures on the bottom 62 at the foot or forward end of the carrier. In some cases, the carrier 60 may have a forward passive connecting element that includes a pair of wire or steel loops (not shown).

The connecting elements of the carrier 60 may vary in location, structure, and form, but are typically configured to securely retain a connection between the infant carrier and a car seat base (not shown) when installed. The typical infant carrier, such as that shown as the carrier 60 herein, is equipped with a car seat base utilized to securely mount and install the carrier in a vehicle on the vehicle's seat. These same active and passive latching mechanisms and connection points may also be utilized as generally shown in this example to mount the infant carrier 60 to the stroller assembly 20.

With continued reference to FIG. 2, the frame assembly 22 includes an infant carrier adapter assembly 70 and a pair of adapter mounts 72 on which the assembly 70 is seated along respective sides of the stroller 20. The assembly 70 is generally configured to pivotably position forward and rearward braces 74, 76 or other seat supports for the carrier 60. As described below, the assembly 70 is generally movable between an in-use configuration as shown in FIG. 2 and a folded configuration for storage with or without the stroller 20. To that end, each brace 74, 76 can be pivoted between a folded or stowed position or orientation for storage and an in-use or support position or orientation in which the above-described connecting elements of the infant carrier 60 are attached thereto. In this example, the forward braces 74, 76 are generally U-shaped tubes having cross members 78, 79 extending between the upper free ends of a pair of laterally spaced arms 80, 81, respectively. The lower ends of the arms 80, 81 are pivotally connected to an adapter hub assembly 82, which generally defines a pivot point B for the braces 74, 76. The cross member 78 of the brace 74 nests up into the recesses 64 of the infant carrier 60 as the hooks 66 engage the cross member.

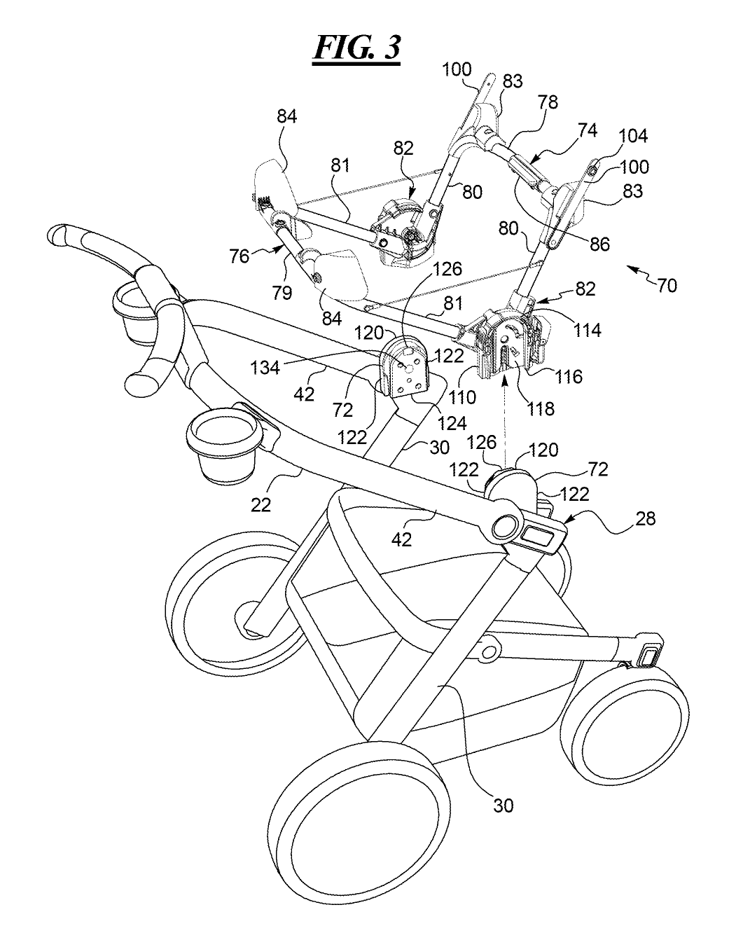

As best shown in FIGS. 3-5, the forward and rearward braces 74, 76 may include further elements to support or engage the forward and rearward ends of the infant carrier 60 when installed on the stroller assembly 20. In this example, the brace 74 includes a pair of laterally spaced apart front mounts 83 secured to the cross member 78 and/or the arms 80 at the junction thereof. The brace 76 includes a pair of laterally spaced apart rear mounts 84 secured to the cross member 79 at or near the junction of the cross member 79 and the arms 81. The brace 74 in this example also includes a latch catch 86 centrally disposed along the cross member 78 between the mounts 83. The latch catch 86 has a lip 88 that may be configured to engage a corresponding projection (not shown) on the carrier 60 to lock the carrier in position. The carrier projection may then be retractable via the above-referenced actuator to release the carrier from the locked position. The front and rear mounts 83, 84 may include a number of projections and mounting elements (e.g., flanges, latch seats, etc.) that provide lateral support, mounting surfaces, and attachment points for the carrier 60 (FIG. 2). For example, the recesses 64 and the hooks 66 (FIG. 2) of the carrier (60) may be disposed adjacent and laterally inward of the front mounts 83 to prevent lateral movement of the carrier 60 when installed on the stroller assembly 20. However, the configuration, location, and construction of the front and rear mounts 83, 84 may vary considerably from the example shown, as they are only configured to suitably engage the connecting elements and other components on the carrier 60. Furthermore, the shape, construction, configuration, and other mechanical and structural characteristics of the braces 74, 76 may vary considerably from the frame tubing-based example described above, insofar as a variety of different types of seat supports may be pivotably movable between in-use and folded orientations.

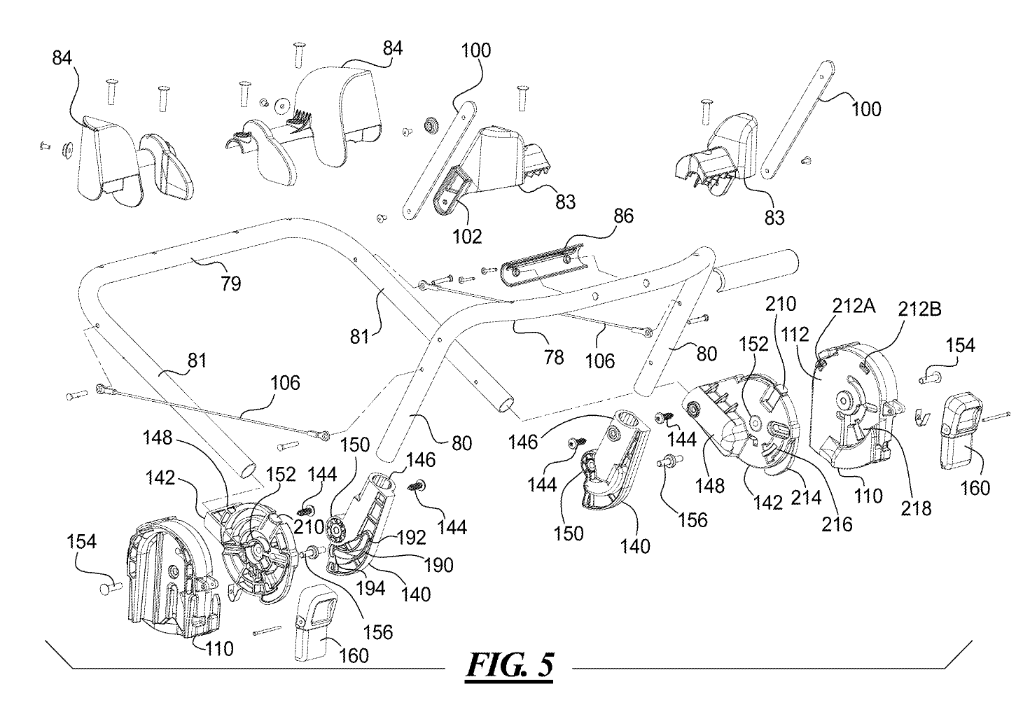

With reference again to FIGS. 1 and 2, an optional shroud 90 wraps around the perimeter of the adapter assembly 70 and the infant carrier 60 when installed on the stroller 20. In this example, side faces 91 of the shroud 90 extend from lower edges 92 positioned near and along the push arms 42 to reach the shell 68 of the infant carrier 60 beneath the seating surface. The side faces 91 begin at respective rearward pivot mounts 94 (FIG. 1), are generally vertically oriented, and extend forward, passing over the adapter hub assemblies 82, where the faces 91 are connected by a front face 96 (shown in phantom in FIG. 2) of the shroud 90. The front face 96 may also be generally vertically oriented, and spans the distance between the pivot joints 28 and the shell 68 of the carrier 60. The shroud 90 may be supported by a U-shaped wire or frame structure 98 (FIG. 1) that may be coupled to the frame assembly 22 at a number of locations in addition to the pivot mounts 94. In this example, as shown in FIGS. 2 and 3, a pair of mounting strips 100 extend upward from clips 102 disposed on the arms 80 to present snap connectors 104 for attachment with the shroud 90. Each clip 102 may be an integral part of the mount 83, as shown in the exploded view of FIG. 5. Corresponding buttons or other snap connectors (not shown) may be disposed on the frame structure 98 or other portion of the shroud 90. A number of additional or alternative locations for the snap connections may be used the shroud 90.

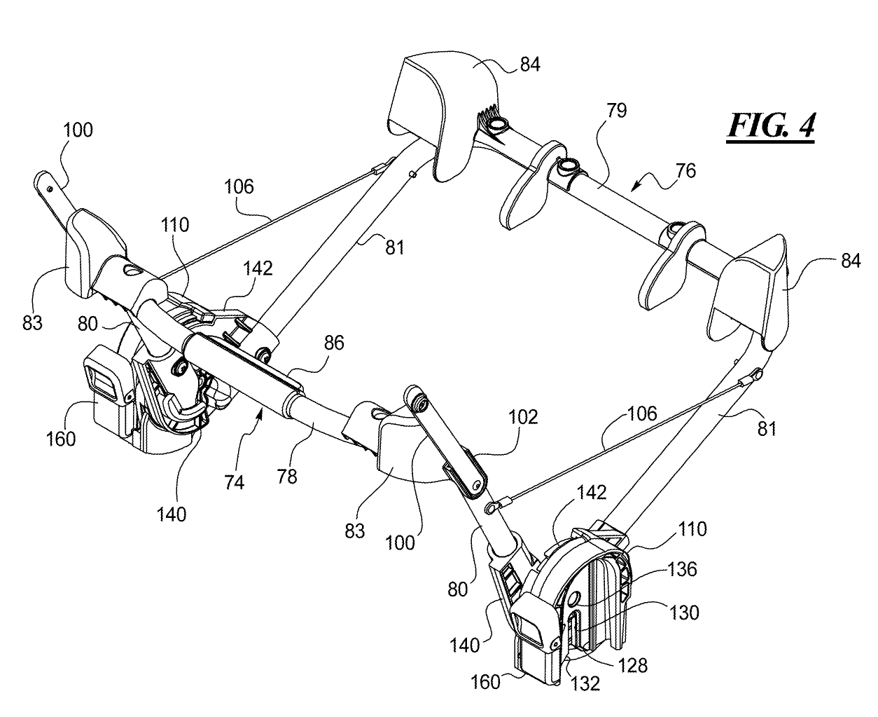

Once snapped or otherwise connected in place, the shroud 90 is configured to mask or cover most, if not all, of the adapter assembly 70 beneath the infant carrier 60. In this way, a caregiver avoids becoming concerned about the details of the adapter hub assemblies 82 or other components of the adapter assembly 70 during use, folding, etc. The shroud 90 may include one or more pockets, zippered pouches, netting, or removable pouches on either an interior (or inward facing) or an exterior (or outward facing) side of the panel to provide storage space. As a result, the shroud 90 covers the mechanics of the adapter assembly 70 and provides an option for additional storage space for diapers, wipes, pacifiers, bottles, and other personal items of the caregiver or child via pockets or pouches sewn into one or more of its faces. Moreover, the shroud 90 may cover wires (e.g., wire rope) or cables 106 (FIG. 2) that link the forward and rearward braces 74, 76. As best shown in FIGS. 4 and 5, the wires 106 are connected between the arms 80, 81 along each side of the adapter assembly 70 and, thus, along the inner surface of the shroud 90. Yet another benefit involves how the shroud 90 covers the adapter assembly 70 (entirely or in part) both during use and when the stroller 20 or the adapter assembly 70 is folded. For example, the adapter assembly 70 can be moved between an in-use orientation and a folded orientation while hub assemblies thereof (described below) remain covered by the shroud 90. In fact, the shroud 90 can cover the adapter assembly 70 regardless of whether the adapter assembly 70 is folded. This feature is generally possible because of an aspect of the adapter assembly 70 described below. Generally speaking, the adapter assembly 70 incorporates a passive fold mechanism(s) that need not be released for movement to the folded orientation or configuration. Without an actuator or other active element involved, a caregiver does not need to access the adapter assembly 70 to fold the stroller 20 or the assembly 70.

In some cases, the shroud includes one or more panels of fabric sewn to a form shaped or fit to engage the adapter, the stroller frame, or both. However, the shroud 90 need not use fabric material, as in the example shown. The shroud 90 may be composed of a variety of soft goods and structural components. The faces 91, 96 of the shroud may be made of any suitable fabric or other flexible material in configurations in which the shroud 90 is collapsible. In other cases, the faces 91, 96 may include rigid or semi-rigid materials, including, for instance, stiffening panels sewn into fabric layers. The shroud 90 may alternatively or additionally use molded plastic or other material(s) capable of forming a cover with or without providing additional storage space.

Further details regarding features of the stroller 20 other than those related to the adapter assembly 70 are set forth in co-pending and commonly assigned U.S. application Ser. No. 12/272,598, entitled “Stroller Assembly and Handle,” filed Nov. 17, 2008, and published on May 21, 2009, as U.S. Patent Publication No. 2009/0127810, the entire disclosure of which is hereby incorporated by reference. For instance, the handle bar 52 and the elevated or raised position of the infant carrier 60 on the frame assembly 22 are described in connection with a number of advantages, including how the infant carrier 60 is mounted in a rear facing orientation so that the caregiver can see the child and, thus, monitor the child's behavior, mood, and condition. Also, the close spacing presented by the handle bar 52 allows the child to more easily see the caregiver, both while the stroller is being pushed and when the stroller has been stopped. In addition, the elevated position of the infant carrier 60 brings the infant closer to the caregiver. Notwithstanding the foregoing, the handle bar 52 and other features of the stroller 20 may vary in shape, construction, and other characteristics, and remain well suited for use in connection with the other aspects of the disclosure set forth herein. For example, the frame assembly 22 may vary considerably in configuration and construction and yet achieve the advantages and benefits disclosed and describe herein, including, but not limited to, the arrangement of front and rear legs, joints, and handle assembly.

The exploded view of FIG. 3 shows the adapter mounts 72 in greater detail. Each mount 72 projects from an exterior but inner facing side of one of the fold joints 28 to define a mounting or attachment point for the adapter assembly 70. The adapter mounts 72 may also serve as the mounting or attachment points for a toddler seat, as described in co-pending and commonly assigned U.S. application Ser. No. 12/410,243, entitled “Foldable Stroller and Fold Interlock Mechanism,” and filed on Mar. 24, 2009, the entire disclosure of which is hereby incorporated by reference. In this example, each adapter mount 72 may be secured to one of the rear legs 30. The adapter mounts 72 may be generally hub-shaped as shown to present a complementary connection element for an outer hub 110 of each hub assembly 82. Each outer hub 110 has an inner side 112 (FIG. 5) secured to the other components of the hub assembly 82, and an outer side 114 with an inverted U-shaped perimeter wall 116 that surrounds on three sides a generally flat face 118 of the outer hub 110. The perimeter wall 116 and the adapter mounts 72 have complementary shapes to facilitate a slidable engagement. To this end, each adapter mount 72 has a rounded top 120, generally linear sides 122, and a generally flat, inner face 124 to match those of the perimeter wall 116 and face 118 of the outer hub 110.

The adapter mounts 72 and the outer hubs 110 may be configured with one or more guides to facilitate the slidable engagement. For example, the flat face 124 of each adapter mount 72 may have a chamfer or ramp 126 disposed along a top edge. Alternatively, and as shown best in the example of FIG. 4, the flat face 118 of each outer hub 110 may have one or more tracks or ribs 128 that seat in a corresponding groove (not shown) formed in the flat face 124 of the adapter mount 72. In such cases, the tracks 128 may act as a key to orient the adapter assembly 70 for proper placement on the stroller 20 (i.e., to prevent a backward installation). The flat face 118 of each outer hub 110 may additionally or alternatively include a groove or channel 130 that widens at a lower edge 132 of the face 118, as shown in FIG. 4. The groove 130 may be configured to guide a complementary button or other projection 134 on the flat face 124 of the adapter mount 72. As the adapter assembly 70 is lowered into position, the button 134 may then engage a receptacle 136 centered within the face 118 (best shown in FIG. 4). The receptacle 136 may be shaped as a detent or hole sized to capture the button 134 in a pressure- or snap-fit engagement. As the button 134 snaps into place, an audible click may be generated to alert the user to the connection. The connection may be secured via further elements, as described below.

Alternatively or additionally, the groove 130 may act as a channel in which a connecting element on the outer hub 110 is captured to establish the connection. The connecting element may have a complementary shape to engage the channel and any ribs, tracks, or grooves thereof. Thus, the configuration of the adapter mounts 72, and the connection arrangement with the outer hub 110, may vary from the embodiment of FIG. 3. The above-referenced application provides one alternative arrangement that uses a similar complementary hub coupling. Another optional connection arrangement is described below.

With reference now to FIGS. 4 and 5, each adapter hub assembly 82 includes an inner hub 140, as well as a middle hub 142 disposed between the inner hub 140 and the outer hub 110, to control the movement and position of the forward and rearward braces 74, 76, respectively. The inner hubs 140 are attached to the arms 80, while the middle hubs 142 are attached to the arms 81. As shown in the exploded view of FIG. 5, each connection may be secured via screws or other fasteners 144 that pass through sleeves 146, 148 of the hubs 140, 142 to engage the arms 80, 81, respectively. The sleeves 146, 148 project outward from inner wheel sections 150, 152, of the hubs 140, 142, through which a rivet 154 or other bolt passes to define the pivot axis B (FIG. 2). The hubs 110, 140, 142 are rotatably coupled via the rivet 154 to the stationary outer hub 110 to support the movement of the adapter assembly 70 between the in-use orientation shown in FIG. 4 and a folded orientation for storage. As described below, each hub assembly 82 is configured to control when the movement can occur via a passive fold mechanism formed via several cam-related features of the hubs 110, 140, 142. Operation of the fold mechanism avoids the need for a release mechanism actively engaged by the caregiver. Instead, the position of a cam pin 156 within the hub assemblies 82 determines when the movement of the adapter assembly 70 to the folded orientation can be initiated.

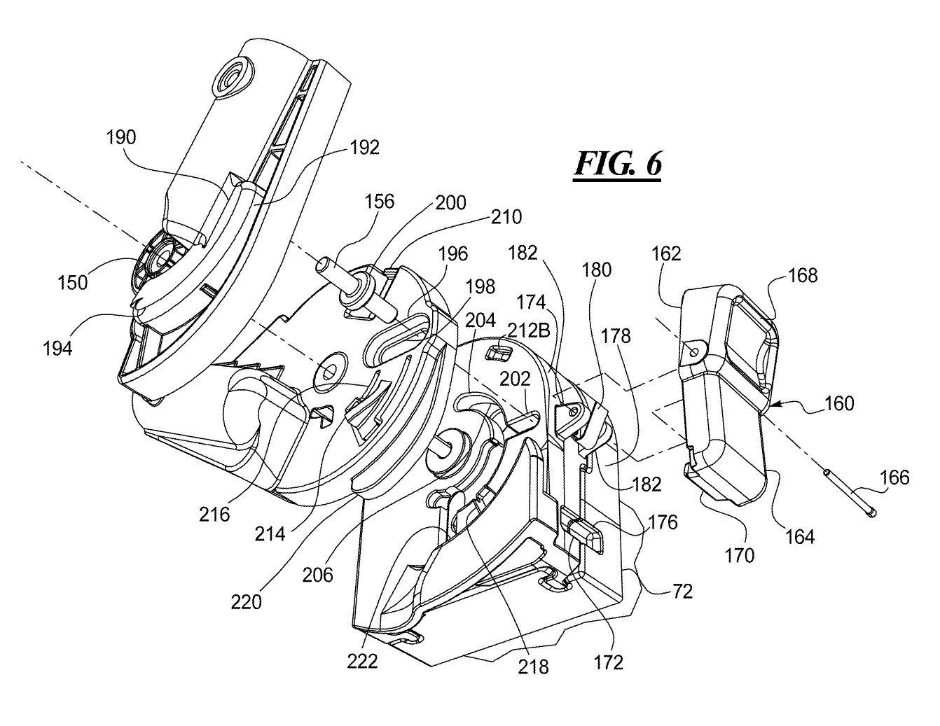

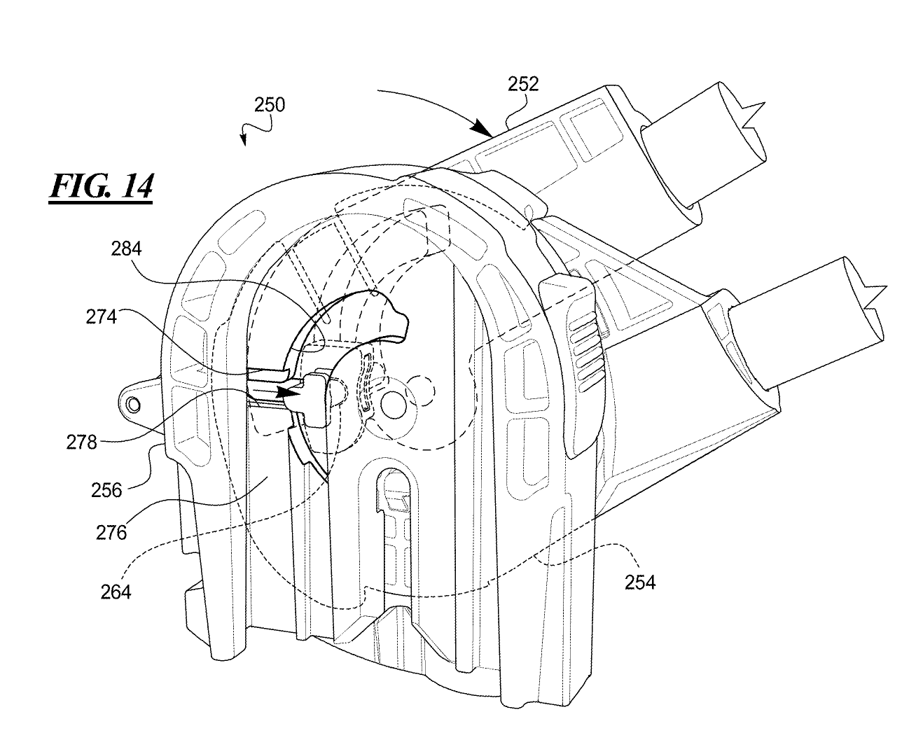

In contrast to the passive nature of the fold release, the exemplary adapter assembly 70 includes a trigger 160 configured for actuation by a user to detach the adapter assembly 70 from the stroller frame 20. As best shown in FIG. 6, the trigger 160 includes a push button section 162 and a latch section 164 that extend radially outward from a hinge pin 166 captured in a lateral through-hole 168. Generally speaking, the trigger 160 acts as a lever to displace the latch section 164 in response to a user depressing the push button section 162. In this example, the section 162 has a recessed grip pad 168 to assist the user in engaging the trigger 160. Another grip pad may be provided on an opposite side of the outer hub 100 (e.g., as shown in the alternative embodiment of FIG. 14) to allow the user to use a single hand to disengage the connection. The grip pad 168 and, more generally, the push button section 162 may be angled outward to provide space for the section 162 to be deflected inward, or toward the hub assembly 82. The section 164 has a hook 170 that projects toward the hub assembly 82 to engage a catch 172 on an outer face 174 of the perimeter 114. In this example, the hook 170 may be shaped as a lip and positioned near a bottom end of the trigger 160 to maximize its travel into and out of the catch 172. The mount adapter 72 also includes a catch 176 on an outer face 178. The catches 172, 176 in this example are shaped as halves of an elongate hole that receives the lip-shaped hook 170. In operation, the lever action of the trigger 160 frees the hook 170 from the catches 172, 176, thereby allowing the hub assembly 82 to be moved relative to the mount adapter 72. Otherwise, a bias spring 180 biases the push button section 162 toward the latched position to keep the hook 170 engaged with both the outer hub 110 and the adapter mount 72. With the hook 170 captured in both of the catches 172, 176, the outer hub 110 cannot be moved relative to the adapter mount 72. In this example, the bias spring 180 may be disposed between a pair of pivot mounts 182 that project outward from the face 174 as shown.

The configuration and construction of the trigger 160 may vary considerably from the example described above. For example, an alternative latch mechanism need not engage both the outer hub 110 and the adapter mount 72 with common latch element. Moreover, the manner in which the adapter assembly 70 is secured to the stroller 20 need not use a lever-based trigger mechanism. A wide variety of passive and active latch mechanisms may be utilized to establish and release the connection. One example of a passive latch mechanism is described below.

With continued reference to FIG. 6, the folding mechanism of the hub assemblies 82 involves the cam pin 156 traveling in respective slots or tracks formed in each hub. Each inner hub 140 has a curved track or cam slot 190 formed on an outward facing side of the hub. The track 190 acts as a cam as the radial distance from the center 150 of the hub 140 varies over the length of the track 190. In this example, the distance to the pivot axis decreases as the pin 156 moves in the pivot track 190 from an end 192 to an end 194, as also shown in FIG. 5. Each middle hub 142 includes a radial slot 196 that includes a rim 198 against which a ring 200 of the pin 156 bears while traveling in the slot 196. Each outer hub 110 also has a radial slot 202 as part of a two-part slot or track 204 that acts as a cam follower. As the pin 156 moves along the cam track 190 from the end 192, the pin 156 is forced to move radially inward along each of the radial slots 196, 202. Once the pin 156 reaches the inner end of the radial slot 202, the pin 156 is then free to travel around an arc slot 206 of the track 204 in the outer hub 110. In this way, the slots 196, 202 act as cam or slot followers to release the adapter assembly 70 for movement to the folded orientation.

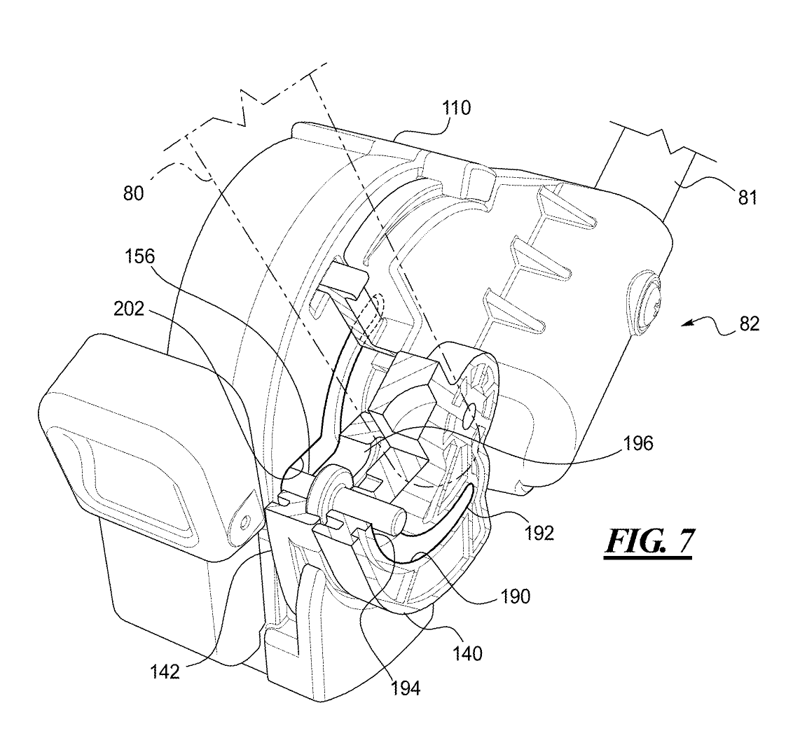

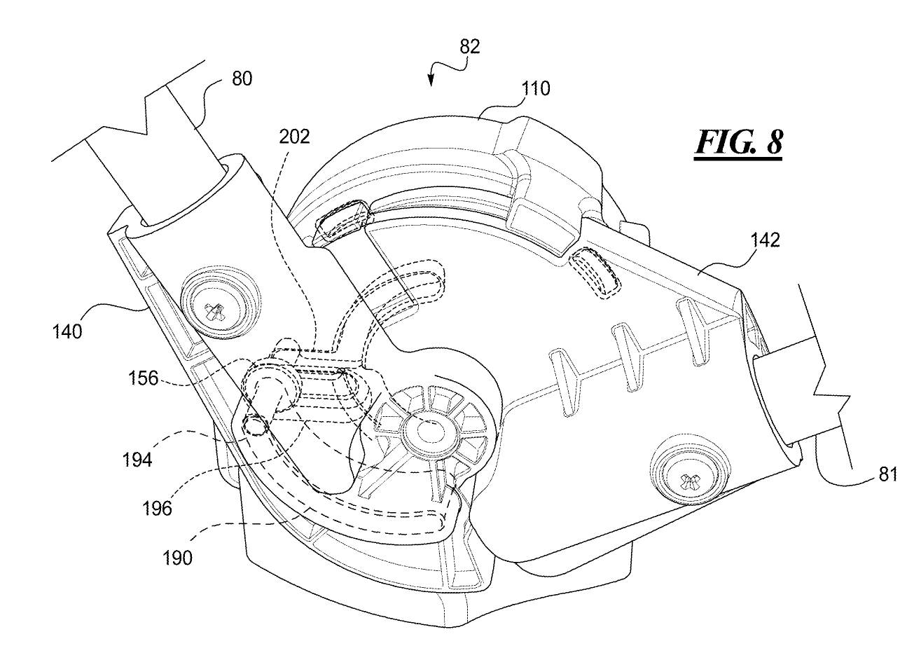

FIGS. 7 and 8 show the hub assembly locked in the in-use orientation. FIG. 7 shows the hub assembly 82 with the inner and middle hubs 140 and 142 partially cutaway to reveal the movement of the pin 156 during movement between an in-use and folded orientations of the adapter assembly 70. In both FIGS. 7 and 8, the hub assembly 82 is disposed in the in-use orientation, with both of the arms 80, 81 opened to extend forward and rearward in their respective positions for accepting the infant carrier 60 (FIG. 1). In this orientation, the pin 156 is disposed at the end 194 of the slot 190 and, thus, remains captured in the radial slots 196 and 202. As a result, the middle hub 142 cannot rotate relative to the outer hub 110, and the arms 81 are locked in place until the pin 156 moves radially inward from the locked position shown. However, in order for the pin 156 to move from the locked position to the released position, the front arms 80 are rotated rearward. Thus, as long as the infant carrier 60 remains mounted on the adapter assembly 70, the hub assemblies 82 will remain in a locked state. That is, the front arms 80 are first rotated forward in order to displace the pin 156 along the cam track 190 and release the adapter assembly 70 to move toward a folded orientation.

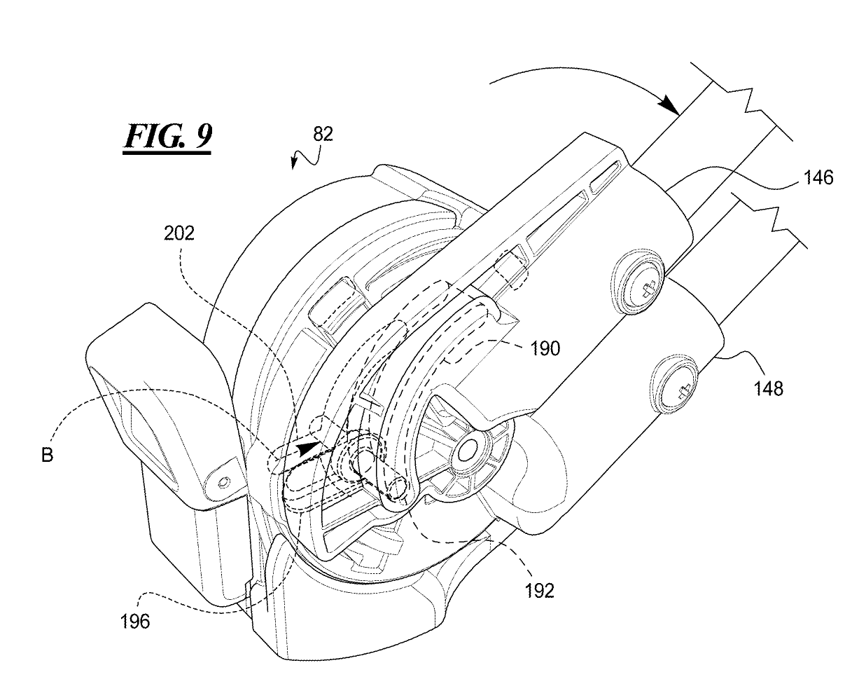

FIG. 9 shows the hub assembly 82 in a released state. The inner hub 140 has rotated relative to the other hubs 110, 142 such that the sleeve 146 of the inner hub 140 is now positioned adjacent the sleeve 148 of the middle hub 142. The arms 80 are now directed rearward in roughly the same direction as the arms 81. As a result of this rotation, the pin 156 has reached the end 192 of the track 190 in the outer hub 140, as well as the inward ends of the radial slots 196 and 202. The pin 156 has traveled radially inward in the direction R as a result of the cam-based nature of the track 190.

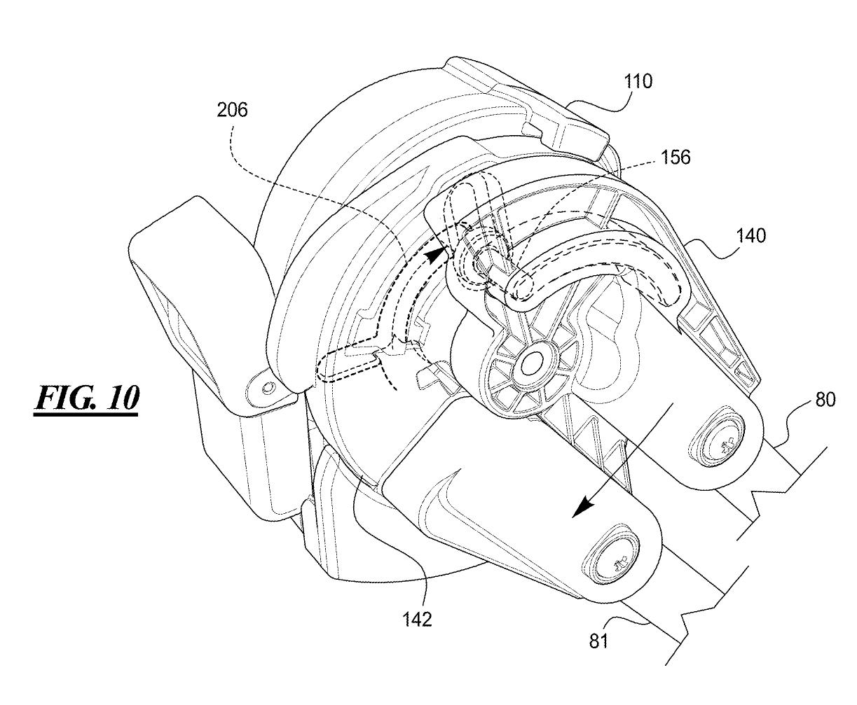

Once in the released state, both of the hubs 140, 142 are free to rotate relative to the outer hub 110 as shown in FIG. 10. Once the pin 156 reaches the released position at the end of the radial slots 196, 202, the pin 156 can travel around the arc slot 206 in the outer hub 110. That travel allows the hubs 140, 142 to rotate together to the folded orientation in which the arms 80, 81 remain adjacent, pointing rearwardly and downwardly as shown.

The middle and outer hubs 142, 110 act as a slot follower system that can be customized or configured to limit the travel of folding arms or other frame components to any desired extent. In this way, the disclosed adapters may be configured and compatible with a variety of stroller designs, stroller seats, and other seats. As long as the adapter assembly 70 is oriented in the in-use position and, thus, open to accepting or receiving, for instance, a car seat carrier, any object that prevents the releasing arm (e.g., the arm 80) from rotating, renders it impossible for the assembly 70 to fold. Moreover, the arrangement and positioning of the rear and forward arms 80, 81 renders it impossible to mount the carrier 60 onto the adapter 70 unless it is in its fully open, or locked, position (i.e., the in-use position).

With the releasing arm of the adapter assembly 70 determining the state of the fold mechanism, the user avoids having to actuate a separate release mechanism to fold the assembly 70 or the stroller 20. This passive locking fold mechanism may be integrated into fold mechanisms in other juvenile product contexts involving, for instance, high chairs, etc., where a seat component or seat occupant is added to the product during use. This mechanism allows the seat or other frame of the juvenile product to be locked or otherwise secured in position during use, but passively unlocked or disengaged as soon as the use ends. In this way, for example, a stroller or high chair may be unlocked for folding as soon as the child is removed from the respective seat.

The hub assemblies 82 may include several other aspects to increase structural integrity, provide user feedback, increase load tolerance, and provide other features in addition to the passive fold mechanism. As shown in FIGS. 5-7, the middle hub 142 includes a prong 210 at the end of a flexible, radially disposed finger. The prong 210 engages a pair of slots 212A, 212B formed in the inner face 112 of the outer hub 110. The prong 210 enters the slot 212A when the assembly 82 reaches the folded orientation, which results in an audible click for user feedback. The prong 210 is disposed in the slot 212B when the assembly is in the in-use orientation.

The middle hub 142 in this example also includes a ramp 214 shown in FIGS. 5 and 6 on which the inner hub 140 rides during movement between the orientations. The ramp 214 is disposed on the inner side of an arc-shaped cutout 216, which has an elongate projection (not shown) on the other side located opposite the end of the ramp 214. When the assembly 82 resides in the in-use orientation, an outer face of the inner hub 140 overlaps the full extent of the ramp 214. However, because the hubs 140, 142 are axially held together by, for instance, the rivet 154, the ramp 214 deflects the projection outwardly into a radial slot 218 in the outer hub 110. As a result, the middle hub 142 is locked in place relative to the outer hub 110, thereby increasing the robustness of the assembly 70 in the in-use orientation. Once the inner hub 140 is rotated relative to the middle hub 142 to release the assembly 70 for folding, the ramp 214 is no longer deflected, and the projection is not captured within the slot 218.

As best shown in FIG. 6, axial movement of the middle hub 142 may also be prevented in this example via a flange or wing 220 that flares radially outward from the disc-shaped main body of the middle hub 142 to engage a trench or groove 222 in the outer hub 110.

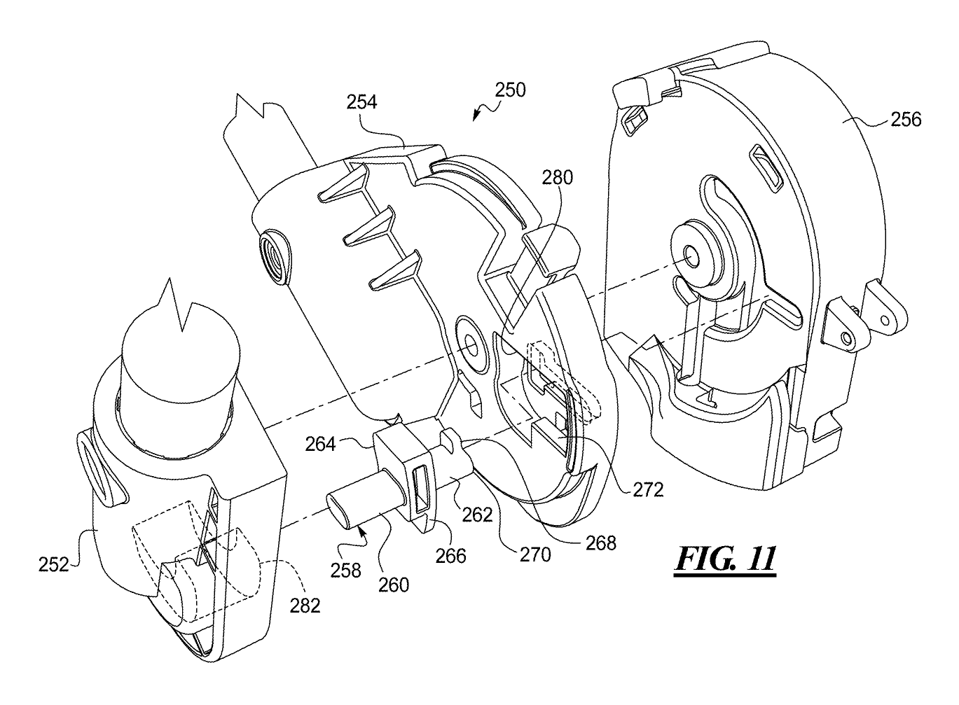

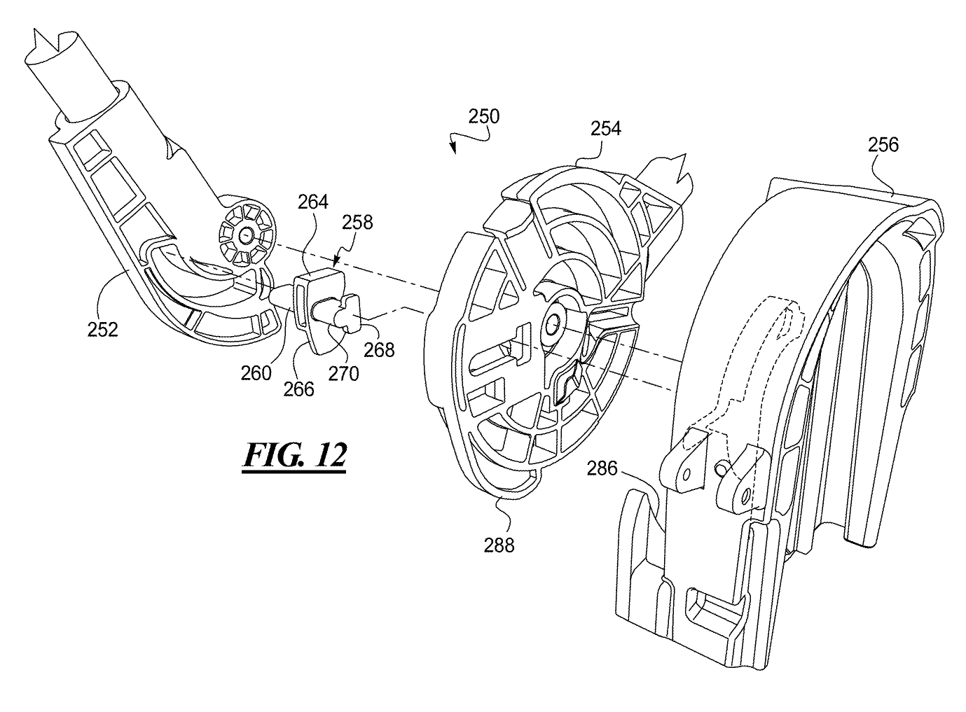

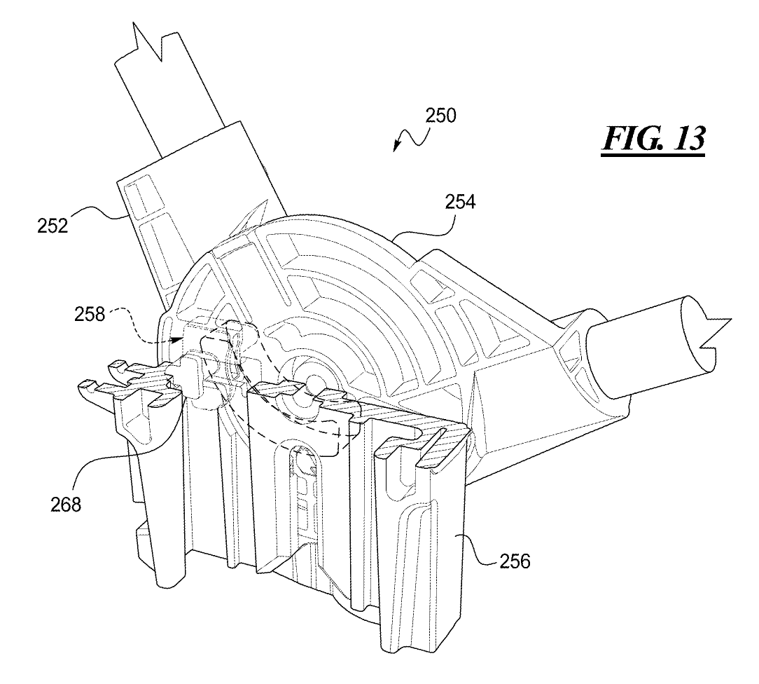

Turning now to FIGS. 11-15, the hub assembly 82 may vary in several ways, including the manner in which the individual hubs are axially constrained. An alternative hub assembly 250 includes inner, middle, and outer hubs 252, 254, 256 that rely on a similar cam follower mechanism, but with modifications to accommodate a cam pin 258 with added radial surface area and otherwise shaped to hold the hubs together. As best shown in FIGS. 11 and 12, the pin 258 includes a pair of axially oriented bars 260, 262 separated by a transverse block 264. The axial bars may be formed from a single bar that passes through the center of the block 264. Each bar 260, 262 may have an ellipsoid or other oblong cross-section. An outer side 266 of the block 264 has a downward extending flange 268, while the bar 262 has a flange 268 at an outer end 270 of the bar 262. The flange 268 extends upwardly and downwardly along the rearward side of the bar 262, thereby forming a T-shaped cross-section.

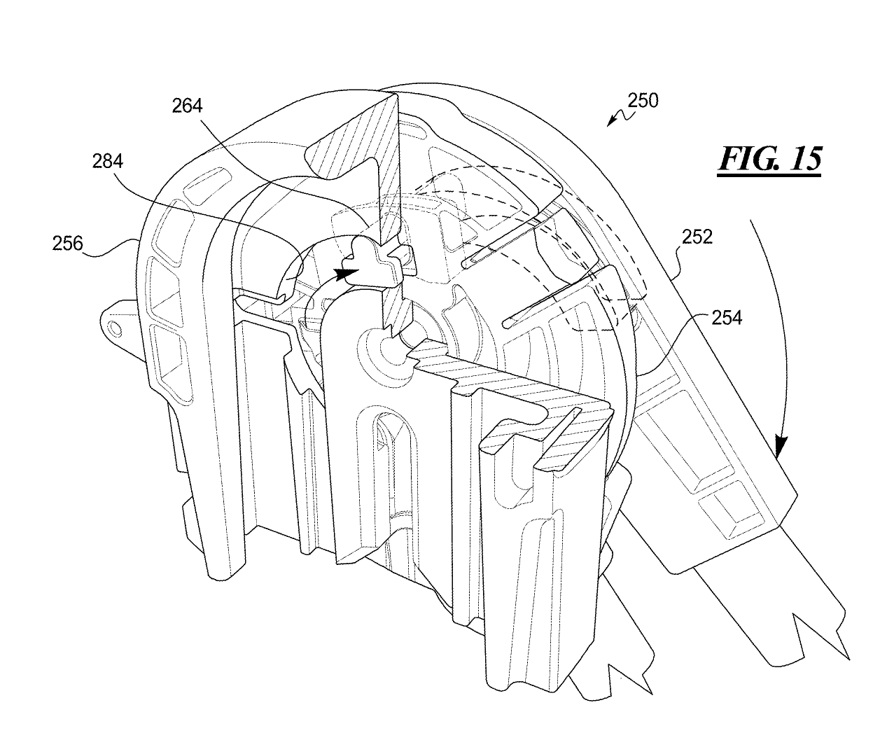

The increased radial surface areas provided by the flanges, the block, and the bars provide multiple bearing areas for the hubs, which together improve axial containment and structural integrity. For example, the flange 268 is captured in a radial channel formed by a wall 272 disposed along an inner face of the middle hub 254 as shown in FIG. 11, while the flange 268 is captured in a groove 274 on an outer face 276 adjacent a slot 278 in the outer hub 256 as shown in FIG. 14. As shown in FIG. 11, a radial slot 280 in the middle hub 254 has been widened to accommodate the height of the block 264, and a cam slot 282 in the inner hub 252 has been widened to accommodate the width of the bar 260. A track 284 in the outer hub 256 has been widened to allow the bar 264 to rotate as the cam pin 258 travels along the arc of the track 284 shown in FIGS. 14 and 15 during the movement from the released state to the folded orientation.

With the increased structural integrity provided by the interaction between the modifications to the cam pin and hubs, the ramp-based lock described above in connection with the embodiment of FIGS. 7-10 is no longer necessary. Nonetheless, as shown in FIG. 12, the outer hub 256 may still include a trench or groove 286 similar to the groove 222 for engagement by a wing 288 of the middle hub 254, as described above.

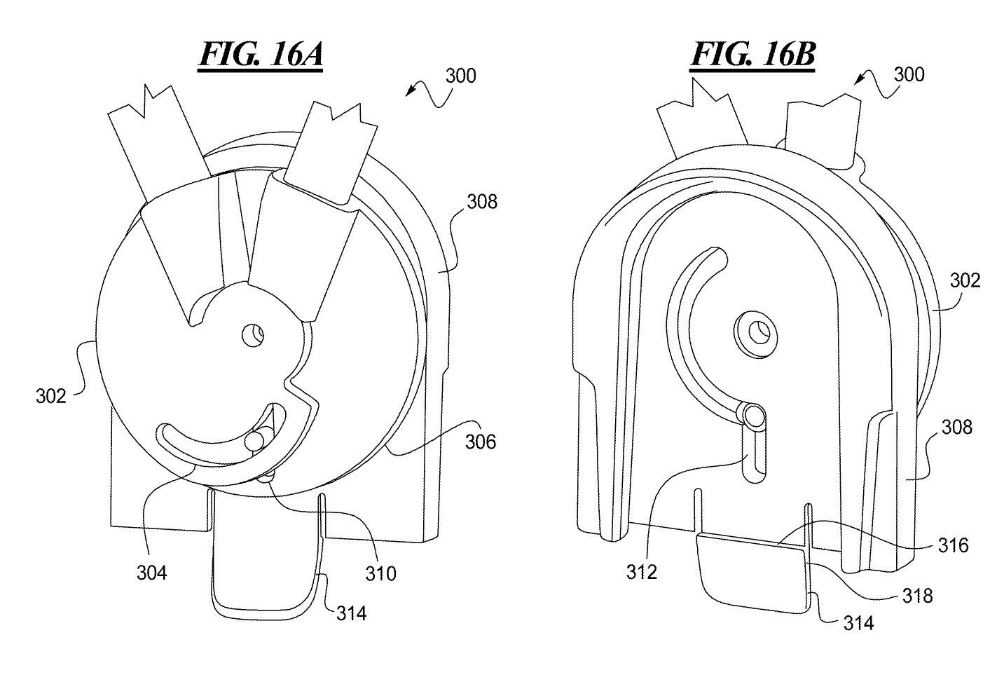

FIGS. 16A and 16B depict yet another alternative hub assembly 300 having a cam-based passive fold mechanism similar to the above-described embodiments. An inner hub 302 again includes a cam slot 304, while middle and outer hubs 306, 308 again include radial slots 310, 312, as shown in FIGS. 16A and 16B, respectively. As shown by this example, the orientation and positioning of the slots may vary from the foregoing embodiments, and still allow the inner hub 302 to rotate its brace toward the brace of the middle hub 304 as shown in FIG. 16A to reach the released, ready-to-fold position shown in FIG. 16B.

Another aspect of the exemplary hub assembly 300 involves its attachment to the stroller frame. In this example, a flexible finger spring 314 projects downward from the outer hub 308 to secure or mount the assembly 300 onto the stroller (not shown). The finger spring 314 has a ledge-shaped catch 316 configured to engage a socket or other receptacle formed in or provided by the stroller frame. In this case, the spring 314 includes a ramp 318 that causes the finger 314 to deflect until the catch 316 is reached to form a snap-fit connection with a counterpart surface in the socket, which may be formed in a hub-shaped mount.

As described above, the disclosed stroller adapters provide the ability to be reconfigured from an in-use orientation to a folded orientation without an active release mechanism for the adapter fold operation. The disclosed adapters also simplify the attachment components needed for securing the adapter to the stroller.

Though not shown herein for ease in illustrating various aspects of the disclosure, the stroller assembly 20 may have a forward facing toddler seat disposed between the frame sides and forward of the handle bar 52. The toddler seat may have a seat frame with a seat back and a seat bottom. Other seat frame components may be configured to engage the above-described socket mounts. The disclosed adapters may be removed to allow attachment of the toddler seat to the frame assembly. The removable toddler seat may be attachable to the frame assembly at the same attachment points as the above-described adapters.

The disclosed adapters may be configured to attain the elevated carrier position described in the above-referenced application, which is intended to move the caregiver and child occupant closer to one another.

Though generally not depicted herein, the stroller assembly 20 may be configured to also incorporate common, optional features such as wheel suspension, accessory and article storage, cup holders, parent or child trays, a canopy, and the like.

Although certain strollers and stroller adapters have been described herein in accordance with the teachings of the present disclosure, the scope of coverage of this disclosure is not limited thereto. On the contrary, all embodiments of the teachings of the disclosure that fairly fall within the scope of permissible equivalents are disclosed by implication herein.

What is claimed is:

1. A juvenile product comprising:
a frame;
a hub assembly mounted on the frame and including first and second hubs;
first and second seat supports coupled to the first and second hubs, respectively, for pivotal movement between an in-use orientation and a folded orientation;
wherein the first hub includes a cam to release the first and second seat supports for the pivotable movement toward the folded orientation in response to rotation of the first seat support.

2. The juvenile product of claim 1, wherein the cam includes a cam slot, and wherein the hub assembly includes a pin that travels in the cam slot and couples the first and second hubs.

3. The juvenile product of claim 2, wherein the pin includes a flange, and wherein the second hub includes a groove in which the flange is captured to hold the first and second hubs axially together.

4. The juvenile product of claim 1, wherein the hub assembly includes a third hub and a pin that engages the cam and includes first and second flanges that engage the second and third hubs, respectively.

5. The juvenile product of claim 1, wherein the hub assembly includes a pin controlled by the cam and a slot follower engaged by the pin.

6. The juvenile product of claim 5, wherein the slot follower includes an arc-shaped track in which the pin travels to allow the first and second seat supports to reach the folded orientation.

7. A juvenile product comprising:
a frame;
an infant car seat adapter mounted on the frame and including a pair of hub assemblies; and
a shroud that enwraps the infant car seat adapter to cover the hub assemblies;
wherein each hub assembly includes a passive fold lock such that the infant car seat adapter can be moved between an in-use orientation and a folded orientation while the hub assemblies remain covered by the shroud.

8. The juvenile product of claim 7, wherein each hub assembly is mounted on the frame and includes first and second hubs, and wherein the infant car seat adapter includes first and second seat supports coupled to the first and second hubs, respectively, for pivotal movement between the in-use and folded orientations.

9. The juvenile product of claim 8, wherein the first hub includes a cam to release the first and second seat supports for the pivotable movement toward the folded orientation in response to rotation of the first seat support.

10. The juvenile product of claim 7, wherein the passive fold lock includes a cam slot, and wherein each hub assembly includes a pin that travels in the cam slot.
